(19) United States
(12) Patent Application Publication
(10) Pub. No.: US 2022/0344982 A1
(43) Pub. Date: Oct. 27, 2022

(54) ROTARY TRANSVERSE FLUX MOTOR

(71) Applicant: MOTX Ltd., Givat Shmuel (IL)

(72) Inventor: Yves VILLARET, Hadera (IL)

(73) Assignee: MOTX Ltd., Givat Shmuel (IL)

(21) Appl. No.: 17/640,854

(22) PCT Filed: Sep. 3, 2020
(86) PCT No.: PCT/IL2020/050966

§ 371 Date: Mar. 7, 2022

Related U.S. Application Data
(60) Provisional application No. 62/896,600, filed on Sep. 6, 2019.

(51) Int. Cl. H02K 1/14; H02K 3/28; H02K 21/12; H02K 41/03

(52) U.S. Cl. CPC H02K 1/145; H02K 3/28; H02K 21/125; H02K 41/031; H02K 2201/12

(57) ABSTRACT

A transverse flux rotating electrical motor comprises a stator and a rotor, the rotor comprising rings of magnets around a shaft, the shaft defining an axial direction of the motor. The stator comprises a plurality of U-shaped magnetic circuit elements each having an open end, a closed end, and upper and lower legs and being oriented on the stator such that their lengths are along the axial direction. The U-shaped elements form rings on the stator around the rotor shaft and the open ends of the elements in a given ring are oriented together along the axis. Windings, also in the form of rings, are inserted into the rings of U-shaped magnetic circuit elements, and the upper and lower legs of the U-shaped elements extend along the axial direction to at least partially enclose one of the rings of magnets of the rotor.

### RELATED APPLICATION/S

The present application claims the benefit of priority under 35 USC § 119(e) of U.S. Provisional Patent Application No. 62/896,600 filed 6 Sep. 2019, the contents of which are incorporated herein by reference in their entirety.

### FIELD AND BACKGROUND OF THE INVENTION

The present invention relates generally to electrical motors, and more particularly, but not exclusively, to permanent magnet multiphase synchronous motors.

Electrical Motors of several types are commonly used in the industry. They are characterized by their size, output torque, maximum speed, efficiency and other properties.

An important property of an electrical motor is the maximum continuous torque output, the rated torque, relative to motor size and weight.

Also it is necessary to consider the ease of assembly during the motor manufacturing process.

A typical electrical motor includes a rotor and a stator, the rotor including a shaft and magnets with opposite and radial magnetization directions.

The stator includes shaped teeth made of magnetizable material made for example from electrical steel laminated sheets, and coils 103a-f are wound around each such tooth.

Three phase currents run in the coils, and the amplitude and phase of the three-phase currents are continuously controlled by a drive to produce the required torque.

The operation of these motors is well known, and this type of motor is widely used.

The maximum torque produced by these motors is directly dependent on the size of the coil and the amount of magnetizable material in the teeth.

For the purpose of increasing torque, it would be desired to increase the number of turns of each winding. However, the amount of space for the windings between the poles is limited, and thus the maximum torque is limited.

If a thinner winding wire is used in order to increase the number of turns in the available space, then the Ohmic resistance of the winding is also increased, and the maximum current applicable is decreased, due to excessive heat dissipation. Finally, the maximum torque available is not increased.

If the number of poles is increased in order to increase the torque, then the available space between poles for the windings is decreased, and thus again the total maximum torque does not increase.

This type of synchronous motor is thus only able to provide a limited torque for a given volume.

Herein, we consider a synchronous multiphase motor, most commonly three phases, but also two-phase motors may be considered.

Common Synchronous Electrical Motors include a stator and a rotor as above. The stator includes a number of poles around which electrical windings are placed. The rotor includes permanent magnets. The magnetic flux produced by the magnets interacts with the magnetic flux created by the current running in the winding to produce a working torque. Desired working torque is obtained by controlling the current in the windings.

Direct Drive Motors are Electrical Motors that use the same principle. They are usually made with a large body diameter, often with a hollow shaft, and include a large number of poles. Direct drive motors are intended for applications with high torque and low speed. Applications includes gearless robot joints and manipulators, electrical vehicles, and high torque industrial applications.

In a Direct Drive Motor, for the purpose of increasing torque, it would be desired to increase the number of turns of each winding. However, with the known motors, the amount of space for the windings between the poles is limited, and thus the maximum torque is limited.

As for the general case, if a thinner winding wire is used in order to increase the number of turns in the available space, then the Ohmic resistance of the winding is also increased, and the maximum current applicable is decreased, due to excessive heat dissipation. Overall, the maximum torque available is not increased.

If the number of poles is increased in order to increase the torque, then the available space between the poles in order to place the windings is decreased, and thus again the total maximum torque does not increase.

This type of synchronous motor is thus able to provide only a limited torque for a given volume.

In another aspect, these Direct Drive Motors usually have a large number of poles and winding. Mounting the winding on the poles, and soldering the wiring ends to connect them to the motor terminals require a significant number of highly skilled working hours, and thus add a significant manufacturing cost.

It would thus be advantageous to design a motor in which the coils are not inserted between the magnetic poles, so that the number of poles can be increased without limiting the number of turns of the coils.

In US Patent Application 2009/0322165 A1 by Rittenhouse a transverse flux motor is described in which the coils serially traverse all the poles. The number of poles can be increased to any number for a same coil size. However, in Rittenhouse's design, the magnetic elements are still mounted around the coil. For this purpose, the magnetic material elements are divided in parts, as seen in FIGS. 2a and 2b thereof, which adds complexity to the motor assembly and increases the cost of production. It is further disclosed therein that the magnets may be placed radially on the rotor, externally to the coil. However this requires that the rotor encloses the stator, resulting in high inertia and expensive and large size bearings, as seen in Rittenhouse FIG. 1a.

Patent U.S. Pat. No. 9,252,650 B2 by Villaret also shows in FIGS. 9, 10 and 11 a transverse flux motor in which the coils serially traverse all the poles. As with the Rittenhouse patent, the magnets are radially mounted externally to the coil. In consequence, to make a feasible assembly, the magnetic material elements must be divided into parts, as seen for example in Villaret FIG. 9 where the magnetic material is divided in parts 905a, 905b, 905c and 905d.

### SUMMARY OF THE INVENTION

The present embodiments may provide electrical motors that produce high torque density with a simplified design, and an object of the present embodiments is to provide an electrical motor capable of generating a higher torque than is possible with the known electrical motor mentioned above. Another object of this invention is to provide an electrical motor with a simplified assembly.

As will be shown below, the present embodiments describe a way to design a transverse flux rotary motor of high torque and simpler construction. In this design, U-shaped magnetic circuits are axially oriented. The U-shaped magnetic circuits can be pre-assembled in blocks, and circular coils are axially inserted.

In another aspect, it is shown below that the motor of the present embodiments may include two magnetic phases driven by a commonly available three phase drive.

An electrical motor of the present embodiments may comprise a transverse flux motor, having concentric windings wherein the magnetic flux runs in a plane parallel to the motor shaft. As will be shown, the number of poles is not limited by the windings, and a large number of poles can be used. For given windings and motor volume, the available torque increases with the number of poles.

A first advantage may include the high torque available for a given motor volume

A second advantage may include the use of simplified windings. Windings are circular and concentric around a shaft, resulting in a simplified manufacturing process.

Yet another advantage is a smaller number of windings required, typically two, not depending on the number of poles.

Yet another advantage is a simplified assembly procedure, resulting in a reduced production cost.

The electrical motor may be driven by a three-phase or two-phase electrical drive.

An electrical motor according to the present embodiments is particularly advantageous for a direct drive configuration, but can also be used for any size of synchronous motor.

As will be shown below, principle shown in the present embodiments may also be applied to a linear motor.

According to embodiments of the present invention there may be provided an electrical rotary motor including:

a stator including U shaped magnetic circuits and two sets of coils;

a rotor including a shaft and magnets, wherein the magnetic flux runs in two series of the U shaped magnetic circuit in planes parallel to the rotation axis, these U shape magnetic circuits being disposed around the shaft and their symmetry axis being parallel to the shaft, wherein the magnets are distributed in two rings concentric with the shaft and with alternating radial magnetization directions, fixed to the motor shaft, and wherein the magnets traverse the U shaped magnetic circuits at their opening along with rotation of the motor and close to the extremities of the U shape.

The two sets of coils may be concentric to the shaft and traverse the U-shaped magnetics circuit in the internal free space of the U shape that is defined by the paths of the magnetic circuits and the magnets.

Upon rotation of the rotor, the angular relative position of the magnet rings and the two series of magnetic circuits produce magnetic fields with angular frequency N in angular quadrature phase difference.

Currents may run in the coils to produce torque and rotation of the shaft.

According to an aspect of some embodiments of the present invention there is provided a transverse flux rotating electrical motor comprising:

a stator;

a rotor;

the rotor comprising one or more rings of magnets around a shaft, the shaft having an axial direction;

the stator comprising a plurality of U-shaped elements, the U-shaped elements comprising an open first end, a closed second end, and upper and lower legs, the upper and lower legs having respective extents towards the first open end, respective U-shaped elements having a length from the first end to the second end, the u-shaped elements being oriented on the stator such that the length is in the axial direction, the plurality of U-shaped elements being located ringwise around the shaft in at least one ring, wherein the open ends of a respective ring are oriented together in a same direction along the axis;

a plurality of windings, the windings extending ringwise around the shaft and being located within the u-shaped elements.

In an embodiment, the upper and lower legs extend respectively above and below the one or more rings of magnets, thereby to form a magnetic circuit linking the plurality of the windings and the ring of magnets.

In an embodiment, the one or more rings of magnets comprises a plurality of magnetic elements, each having a magnetic orientation in a radial orientation relative to the shaft.

In an embodiment, the magnetic elements have respective magnetic orientations which are alternately inward and outward around the ring.

In an embodiment, the ring or rings of magnets comprise a plurality of magnetic elements, each magnetic element having a cross section in a radial orientation relative to the shaft being one member of the group comprising a parallelepiped and a section of a cylinder.

In an embodiment, each magnetic element comprises a cross section in a radial orientation relative to the shaft being one member of the group comprising a parallelepiped and a section of a cylinder.

In an embodiment, the rotor comprises a cylinder for mounting the rings of magnets, the cylinder defining a space around the shaft to fit respective inner legs of the U-shaped elements between the shaft and the cylinder.

A motor may typically have two rings of U-shaped elements and two rings of magnets, or three of each or more.

In an embodiment, legs of a first of the two rings of U-shaped elements are offset with respect to legs of a second of the two rings of U-shaped elements.

In an embodiment, the stator comprises a plate with gaps for fitting the U-shaped elements.

In an embodiment, the one or more rings of magnets are located centrally of two of the rings of U-shaped elements in the shaft axial direction, respective open ends of the U-shaped elements facing centrally towards the magnet rings in the shaft axial direction, and the plurality of windings being located outwardly of the magnet rings in the shaft axial direction.

In an embodiment, at least two rings of the magnets are located outwardly of two rings of the U-shaped elements in the shaft axial direction, the U-shaped elements of respective rings being placed back to back and the open ends of the U-shaped elements facing towards the magnet rings in the shaft axial direction, respective windings of each ring of U-shaped elements being located inwardly of the magnet rings in the shaft axial direction.

In an embodiment, the one or more rings of U-shaped elements are arranged such that angular distances between respective U-shaped elements are offset from being equidistant.

In an embodiment, the ring or rings of magnets comprise magnets attached on an inner side of a mounting cylinder radially towards the shaft, and/or the rings of magnets comprises magnets attached on an outer side of a mounting cylinder radially away from the shaft, and/or the rings of magnets comprises magnets attached on an inner side and an outer side of a mounting cylinder radially in relation to the shaft.

In an embodiment, the windings are connected for a three-phase current. In such a case the motor may have two rings of U-shaped elements, each containing two windings. The windings are then connected to the three-phase input so that the different phases of the input run through the windings as follows:

A first phase current is connected to run though a first winding of the first ring of U-shaped elements,

A second phase current is connected to run through the first winding of the second ring of U-shaped elements, and

the third phase current is connected to run in both:
a) the second winding of the first ring of U-shaped elements, and
b) the second winding of the second ring of U-shaped elements.

According to a second aspect of the present invention there is provided a transverse flux linear electrical motor comprising:

a stationary part having a travel axis;

a moving part configured to move along the travel axis;

a first one of the stationary and moving parts comprising one or more rows of magnets extending along the travel axis and one or more coils having an upper length parallel to the row of magnets;

a second one of stationary and the moving parts comprising a plurality of U-shaped elements, the U-shaped elements respectively comprising an open first end, a closed second end, and upper and lower legs, the upper and lower legs having respective extents towards the first open end, the U-shaped elements having an element length from the first end to the second end, the u-shaped elements being oriented such that the element length is perpendicular to the travel axis, the plurality of U-shaped elements being located lengthwise along the travel axis in one or more rows, wherein the open ends of a respective row of U-shaped elements are oriented together in a same direction along the travel axis, wherein the upper and lower legs of the respective U-shaped elements enclose magnets of the row of magnets and a cross section of the upper length of the coil.

In an embodiment, the row of magnets is located on the stationary part and the row of U-shaped elements is located on the moving part.

In an embodiment, the stationary part comprises a second row of magnets and a second coil and the moving part comprises a second row of U-shaped elements.

In an embodiment, the row of magnets is located on the moving part and the row of U-shaped elements is located on the stationary part.

The transverse flux rotary or linear motor as described herein may form at least part of a robot arm.

According to a third aspect of the present invention there is provided a method for manufacturing a rotary transverse flux motor comprising:

providing a stator mounting;

inserting U-shaped elements into the stator mounting to form an element ring, the U-shaped elements respectively comprising an open side and an internal space, the open side being oriented to face outwardly from the plate;

inserting a ring-shaped wound coil into the ring of U-shaped elements;

providing a shaft with a cylinder mounted thereon;

mounting magnets on the cylinder to form a magnet ring around the shaft; and

fitting the shaft and the cylinder with respect to the stator mounting such that the shaft and cylinder are rotatable and the magnet ring fits in the element ring alongside the ring-shaped wound coil.

According to a fourth aspect of the present invention, there is provided a method for manufacturing a linear transverse flux motor comprising:

providing a static part;

providing a moving part;

mounting the moving part movably on the static part to move along a travel axis;

inserting U-shaped elements into a first member of the group consisting of the static part and the moving part, to form an element row, the U-shaped elements respectively comprising an open side and an internal space;

mounting one or more wound coils and rows of magnets on a second member of the group, the wound coil being elongated in the travel axis to provide a first elongated length and a second elongated length, the first elongated length being parallel to and level with the row of magnets, wherein the magnet row and the first elongated length fit into the internal space.

According to a fifth aspect of the present invention there is provided an electrical rotary motor comprising:

a stator, the stator comprising a plurality of U shaped magnetic circuit elements having open ends respectively, and an axis of symmetry, and at least two sets of coils, the U shaped magnetic elements placed in a ring, and the coils inserted into the ring;

a rotor including a shaft and magnets, the magnets being arranged in two rings concentric with the shaft and with alternating radial magnetization directions, the rings of magnets being fixed to the shaft, wherein the stator is arranged around the shaft such that the axis of symmetry of the U shape magnetic circuit elements is parallel to the shaft, and the rings of magnets extend within the U shaped magnetic circuit elements at the respective open ends along with rotation of the motor, magnetic flux thereby running along the U shaped magnetic circuit element in planes parallel to the rotation axis.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows the principle of a prior art synchronous motor;

FIG. 2 is a simplified perspective view of an embodiment of the present invention;

FIG. 3 is a simplified schematic view of a rotor according to embodiments of the present invention;

FIG. 4 is a simplified schematic view of a U-shaped magnetic circuit according to embodiments of the present invention;

FIG. 5 shows a magnet structured for use in embodiments of the present invention;

FIG. 6 is a simplified schematic view of a rotor according to embodiments of the present invention in which magnets are fixed to outside and inside faces of a cylinder made of ferromagnetic material;

FIG. 7 is a simplified schematic diagram which shows an embodiment of the present invention in which ferromagnetic material fills the space between the U shape magnetic circuits thus forming two shaped volumes;

FIG. 8 is a simplified schematic diagram which shows the one-piece shape body including the magnetic circuits on one side according to an embodiment of the present invention;

FIG. 9 is a simplified schematic diagram showing how U-shaped laminated magnetic circuits are inserted in a shaped body according to embodiments of the present invention;

FIG. 10 is a simplified schematic diagram of a linear motor according to embodiments of the present invention with two double rows of magnets;

FIG. 11 is another view of the embodiment of FIG. 10;

FIG. 12 is a simplified diagram showing a linear motor with double U shaped magnetic circuits according to an embodiment of the present invention;

FIG. 13a is a simplified schematic diagram showing a motor according to a further embodiment of the present invention in which the U-shaped magnetic circuits have openings at opposite sides;

FIG. 13b is a simplified schematic diagram showing the rotor of the motor of FIG. 13a;

FIG. 13c is a simplified schematic diagram showing a magnetic circuit part of the motor of FIG. 13a;

FIG. 14a is a simplified schematic diagram showing an embodiment of an electric motor according to the present embodiments in which a single row of magnets is used for each phase;

FIG. 14b is a simplified schematic diagram showing the rotor of the motor of FIG. 14a;

FIG. 15 is a simplified schematic diagram showing a three-phase motor according to embodiments of the present invention;

FIGS. 16a and 16b are two simplified cross-sectional views showing winding according to embodiments of the present invention;

FIG. 17 is a simplified schematic diagram showing a variation of a motor according to the present embodiments in which the angular distances between the magnetic circuits are varied;

FIG. 18 is a simplified diagram illustrating a method of manufacture of a rotary electric motor according to embodiments of the present invention; and

FIG. 19 is a simplified flow chart illustrating which illustrates a method for manufacturing a linear transverse flux motor according to embodiments of the present invention.

### DESCRIPTION OF SPECIFIC EMBODIMENTS OF THE INVENTION

The present invention, in some embodiments thereof, relates to electrical motors.

A transverse flux rotating electrical motor according to the present embodiments comprises a stator and a rotor, the rotor comprising rings of magnets around a shaft, the shaft defining an axial direction of the motor. The stator comprises a plurality of U-shaped magnetic circuit elements each having an open end, a closed end, and upper and lower legs and being oriented on the stator such that their lengths are along the axial direction. The U-shaped elements form rings on the stator around the rotor shaft and the open ends of the elements in a given ring are oriented together along the axis. Windings, also in the form of rings, are inserted into the rings of U-shaped magnetic circuit elements, and the upper and lower legs of the U-shaped elements extend along the axial direction to at least partially enclose one of the rings of magnets of the rotor.

As an alternative, the ring of magnets and the windings may be mounted on the stator and the U-shaped elements may be mounted on the rotor.

A linear motor may be constructed with a stator and a moving part. The construction is the same except that instead of rings, the magnets and the U-shaped elements are set out in rows along an axis of travel, and the windings are elongated.

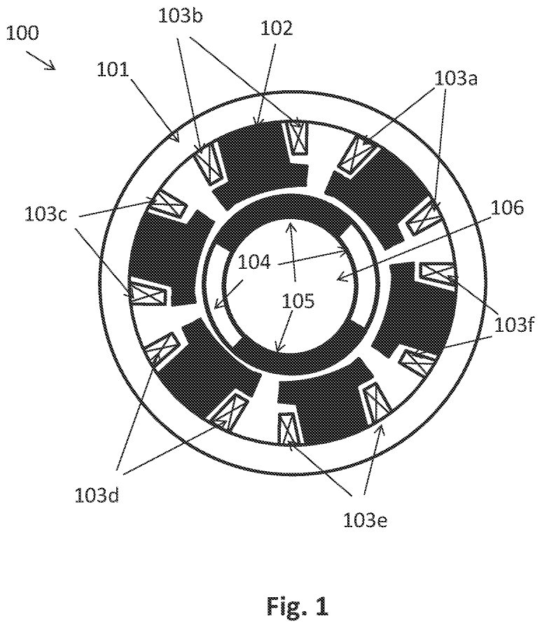

For purposes of better understanding some embodiments of the present invention, reference is now made to the construction and operation of a known synchronous motor as illustrated in FIG. 1.

Motor (100) includes a rotor and a stator, and the rotor includes a shaft (106) and magnets (104, 105) having opposite and radial magnetization directions.

The stator includes shaped teeth such as tooth 102 made of magnetizable material, for example electrical steel laminated sheets may be used, and coils 103a-f are wound around each such tooth.

Three phase currents [symbol] , Iᵥ, I_{w} are run in the coils in circular order, i.e. Iᵤ is run in coil 103a and 103d. Iᵥ is run in coil 103b and 103e, I_{w} is run in coil 103c and 103f.

The amplitude and phase of the three-phase currents [symbol] , Iᵥ, I_{w} are continuously controlled by a drive to produce the required torque.

The operation of these motors is well known, and this type of motor is widely used.

As explained, the maximum torque produced by these motors is directly dependent on the size of the coil and the amount of magnetizable material in the teeth. It would be desirable to increase the number of turns of each winding. However, the amount of space for the windings between the poles is limited, and thus the maximum torque is limited. Conversely, if a thinner winding wire is used in order to increase the number of turns in the available space, then the Ohmic resistance of the winding is also increased, and the maximum current applicable is decreased, due to excessive heat dissipation. Overall, the maximum torque available is not increased.

If the number of poles is increased in order to increase the torque, then the available space between poles for the windings is decreased, and thus again the total maximum torque does not increase.

This type of synchronous motor is thus able to provide only a limited torque for a given volume.

The present embodiments may thus provide a transverse flux rotating electrical motor having a stator and a rotor in which the rotor is made up of one or more rings of magnets around a shaft. The magnets are typically mounted on a cylinder that is fixed to the shaft and leaves some space between the shaft and the cylinder. The shaft defines an axial direction for the motor.

The stator has ring of U-shaped elements with an open end, a closed end and upper and lower legs extending from the closed end. The u-shaped elements are formed into a ring around the stator and are oriented so that the open direction faces along the axial direction. Ring shaped windings are fitted into the ring of U-shaped elements. The upper and lower legs extend beyond the windings and the rotor is positioned so that the ring of magnets is also enclosed within the ring of U-shaped elements, the inner leg of each U-shaped element fits in the space between the cylinder and the shaft of the rotor. A magnetic circuit through the U-shaped elements links the windings and the ring of magnets with a flux direction that is along the axial direction of the motor.

The torque may then be proportional to the amount of current in the windings.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

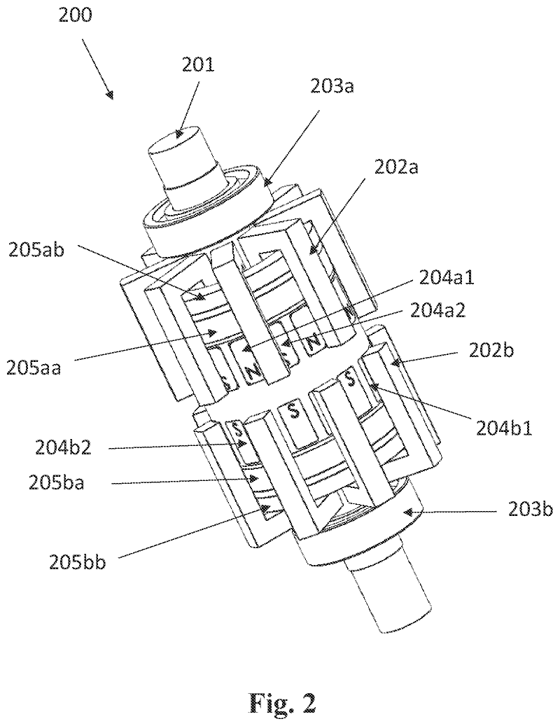

A motor 200 according to an embodiment of the present invention is shown in FIG. 2, and includes a rotor and a stator.

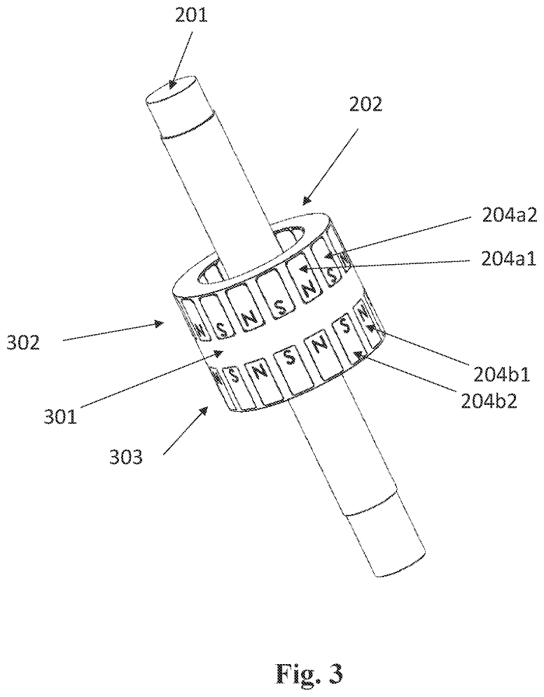

The rotor includes a shaft 201 which rotates inside a motor frame, not shown, on bearings 203a and 203b. The rotor is shown separately in FIG. 3. On the central part of shaft 201, a cylinder 301 is mounted and fixed so as to be concentric with the shaft.

The cylinder may have an internal diameter significantly larger than the shaft diameter, and a sufficient thickness to allow the insertion of multiple magnets 204a1, 204a2, 204b1, 204b2. The magnets 204a1, 204a2, 204b1, 204b2 are arranged in two rings 302, 303 on both sides of the central circumference of the cylinder 301.

On each ring, magnets are uniformly distributed on the circumference with alternating magnetic orientation in the radial direction.

In the rotor embodiment shown in FIG. 3, the magnets 204a1 and 204a2 are located on the ring 302. Magnet 204a1 has an outward radial magnetic orientation, and magnet 204a2 has an inward radial magnetic orientation. The outward and inward directions are labelled N and S for North magnetic pole and South magnetic pole respectively.

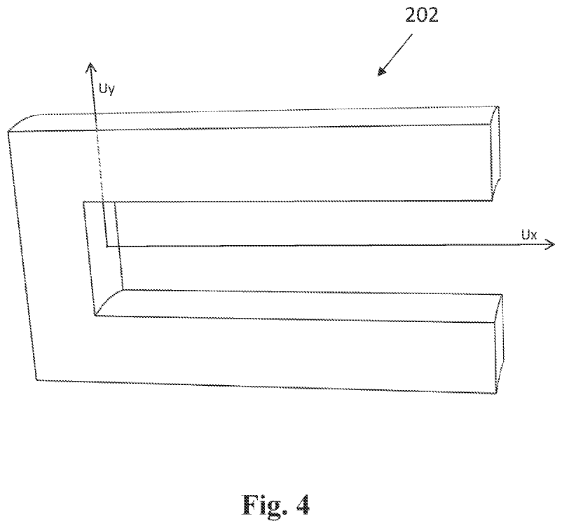

Similarly, magnets 204b1 and 204b2 are on the ring 303. Magnet 204b1 has an outward radial magnetic orientation, and magnet 204b2 has an inward radial magnetic orientation. Referring again to FIG. 2, two series of U-shaped magnetic circuits 202a and 202b are evenly distributed around the shaft. A U-shaped magnetic circuit 202 is shown in FIG. 4. Two axes Ux and Uy are shown to define the orientation of the U-shaped magnetic circuit. The two series of magnetic circuits shown in FIG. 2 are disposed uniformly around the shaft so that their Ux axes are parallel to the shaft axis and their Uy axes are radial. The two series of magnetic circuits are disposed on both side of the cylinder 301, so that the two rings of magnets 302 and 303 pass through their openings, close to their extremities, namely the ends of the legs of the U-shaped magnetic circuit elements.

Referring to FIG. 2, two sets of two circular coils 205aa, 205ab and 205ba, 205bb are concentric to the shaft and pass through the remaining free space between the two legs of the U-shaped magnetic circuit elements. In the embodiment shown in FIG. 2, each set of coils includes two coils of different width. As will be shown, this embodiment is suitable for a three-phase motor operation. An alternative embodiment in which each set of coils includes only one coil is suitable for two-phase motor operation.

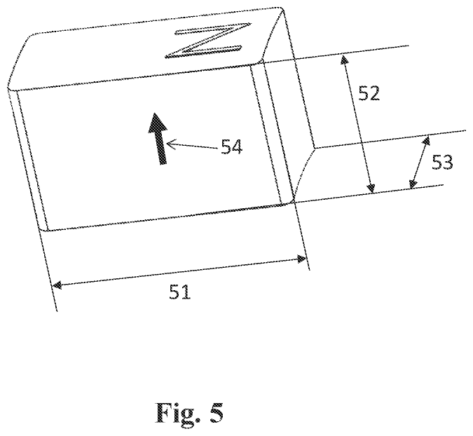

In the presently described embodiment, the magnets form a parallelepiped, alternately known as a rhomboid, so that the face radially away from the shaft is longer than the face towards the shaft. An exemplary magnet suitable for use herein, is shown in FIG. 5, having a length 51, which may be aligned along the axial direction of the shaft, a thickness 52 in the radial direction and a width 53.

It should be understood that magnets of different shape may be used. In particular, a magnet having upper and lower surfaces perpendicular to the radial direction, may have a cylindrical cross section to be concentric with the shaft.

Referring now to FIG. 3, a rotor comprises a cylinder 301, magnets 204a and 204b and shaft 201. The parts comprising the rotor are fixed together and rotate as part of the rotation of the rotor.

The U-shaped magnetic circuit elements and the coils are parts of the stator and are static.

Magnet angular positions are arranged in such a way that a series of magnets such as the ring of magnets 204a1, hereinafter magnet series a, are in quadrature with a second series of magnets 204b1, hereinafter magnet series b. The term quadrature as used herein refers to angular offsets between the two series of magnets. Specifically, while rotating, when magnets of series b are exactly positioned between the legs of the u-shaped magnetic circuit line 202b, hereinafter magnetic circuits series b, then the legs of the magnetic circuits series a are exactly centered with the separating space between two magnets of magnet series a.

The motor of the present embodiments may thus provide high torque and a simplified assembly process. Because of the axial orientation of the U-shaped magnetic circuit, the U-shaped magnetic circuits on one side, such as 202a, may be pre-assembled on a body structure. Pre-wound coils 205aa,205ab may then be inserted so as to pass inside all of the U-shaped magnetic circuit. Then the pre-assembled body structure, with the U-shaped magnetic circuit, for example circuit 202, and the coils 205aa, 205ab are placed on the rotor enclosing the magnet rings as shown in FIG. 3, 302. Such a simplified mounting means that the U-shape magnetic circuits may be provided as complete structures and do not need to be made in parts and subsequently assembled.

The principle of operation for an embodiment of the present invention is as follows.

Upon rotating the magnets a flux is induced in the magnetic circuits. Since magnetic angular positions are in quadrature for series a and series b as explained hereinabove, they induce flux in quadrature in the series a and series b magnetic circuits. These fluxes may be approximated to:

Øₐ=Ø₀·cos(α) eq. 1

Ø_{b}=Ø₀·sin(α) eq. 2

Where α is the angular position of the shaft.

If a shaft rotates with an angular speed w then the fluxes may create a voltage in the coils according to the general formulae:

V1=−N·Ø₀·ω·sin(α) for the coils traversing the a series of magnetic circuits, and V2=N·Ø₀·ω·cos(α) for the coils traversing the b series of magnetic circuits, where
N designates the number of turns wound on the respective coil.

In an embodiment, there may be two sets of two coils 205aa, 205ab on one side, and two sets of two coils 205ba, 205bb on the other side. The respective voltages induced in these coils will then be:

Vₐₐ=−Nₐₐ·ω·Ø₀·sin(α) eq. 3

V_{ab}=−N_{ab}·ω·Ø₀·sin(α) eq. 4

V_{ba}=N_{ba}·ω·Ø₀·cos(α) eq. 5

V_{bb}=N_{bb}·ω·Ø₀·cos(α) eq. 6

To operate the motor, an electric drive is used to drive currents in the coils, respectively Iₐₐ, I_{ab}, I_{ba}, I_{bb}

The electromechanical power input to the motor is then calculated by

P=Iₐₐ·Vₐₐ+I_{ab}·V_{ab}+I_{ba}·V_{ba}+I_{bb}·V_{bb} eq. 7

Using equations 3 to 7 the electromechanical power is expressed as:

P=ω·Ø₀·[−(Nₐₐ·Iₐₐ+N_{ab}·I_{ab})·sin(α)+(N_{ba}·I_{ba}+N_{bb}·I_{bb})·cos(α)] eq. 8

To operate the motor, the electrical drive is programmed to drive the currents, so as to obtain:

Nₐₐ·Iₐₐ+N_{ab}·I_{ab}=−Iₜ·sin(α) eq 9

N_{ba}·I_{ba}+N_{bb}·I_{bb}=Iₜ·cos(α) eq. 10

Iₜ·sin(α) represents the sum of all currents running coils 205aa and 205ab
Iₜ·cos(α) represents the sum of all currents running coils 205ba and 205bb

Then the electromechanical power is given by:

P=ω·Ø₀·Iₜ ep 11

The electromechanical power is also expressed as a function of the torque T:

P=ω·T eq 12

By substitution for P from eq 11 the motor torque is:

T=Ø₀·Iₜ eq 13

A motor according to the present embodiments may thus be controlled to output a torque T by selecting a value Iₜ and driving currents in the coils according to eq 9 and eq 10.

### Coils Arrangement and Operation Mode:

A motor according to the present embodiments may be configured for operation with a two-phase electrical drive or with a three-phase electrical drive.

In a configuration for a two-phase electrical drive, only two coils, 205aa and 205ba, one on each side, are installed.

In that case, to generate a torque T=Ø₀·Iₜ, the drive may set the currents according to

Iₐₐ=−Iₜ·sin(α)

I_{ba}=−Iₜ·cos(α)

Two-phase drives are not commonly used because they are less efficient. Specifically, they need the same number of switching devices, such as IGBT's, as the three-phase drive, but require a higher current rating. Hence it is usually preferable to use a three-phase drive.

To operate the motor of the present embodiments with a three-phase drive, all coils shown in FIG. 2 are installed.

All coils are wound in the same direction, that is in either the clockwise or anticlockwise direction from a start extremity to an end extremity. The current direction is defined as positive when current is running from the start extremity to the end extremity.

The three-phase drive may control three currents Iu, Iv and Iw. Hereinbelow, an embodiment is disclosed wherein the number of turns of each coil and the interconnection of the coils allows the motor to be driven by a three-phase drive.

It must be understood that other designs are possible for the number of turns and the connection of the coils to allow a three-phase drive operation.

In the present embodiment, coil 205a is connected to phase U of the drive, and the current Iu is run into coil 205a.

Likewise, coil 205b is connected to phase V of the drive and the current Iv is run into coil 205b.

Coils 205ab and 205bb are connected in series, in the same direction. The phase W current I_{w} is run in these coils, in reverse direction (−I_{w}).

The number of turns of the coils 205ba (N_{ba}), 205ab (N_{ab}) and 205bb (N_{bb}) is set in relation to the number of turns of coil 205aa (Nₐₐ) by:

N_{ba}=Nₐₐ

N_{ab}=N_{bb}=β·Nₐₐ Where β=(\sqrt{3}−1)/2

Since the numbers of turns are integer numbers, N_{w} is rounded to the closest integer value.

Three-phase drives commonly produce three currents which are controlled for phase θ and amplitude I:

Iᵤ=I·cos(θ)

Iᵥ=I·cos(θ+2·pi/3)

I_{w}=I·cos(θ−2·pi/3)

It can be shown that the total of all currents inside magnetic circuits such as 202a and like 202b respectively is:

$${I}_{ta} = K . {N}_{aa} . I . cos ( θ + \frac{pi}{12} ) \\ {I}_{tb} = K . {N}_{ab} . I . sin ( θ + \frac{pi}{12} )$$

### Where K≈1.2247

The above two total currents are in quadrature.

Consequently, by the same principle shown above for a two-phase drive, using a three-phase drive and two sets of three coils it is possible to produce, by controlling the phase θ and amplitude I, two total currents Ita and Itb in quadrature running inside the magnetic circuits to generate a desired torque and rotate the rotor.

Other variations may be based on the principles of the present embodiments, as will be apparent to the person skilled in the art.

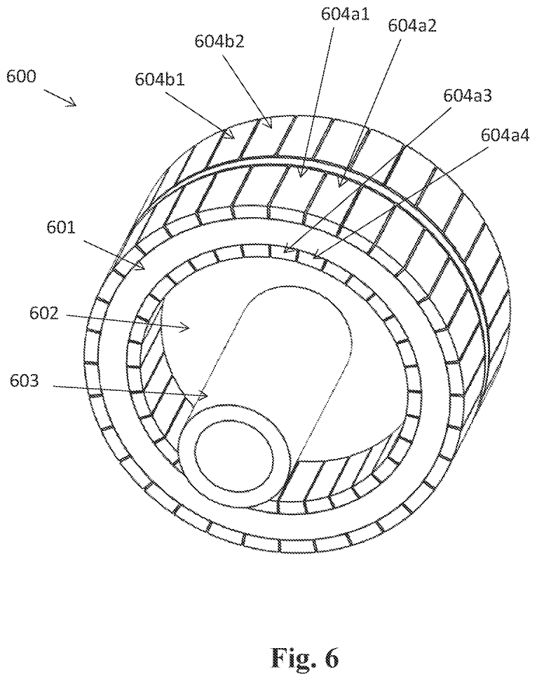

In FIG. 6 is shown a further embodiment of the rotor. An advantage of the embodiment of FIG. 6 is that it allows the use of a bigger coil and smaller magnets. In FIG. 6, magnets 604a1, 604a2, 604a3 and 604a4 are glued on a cylinder 601 made of magnetizable, or ferromagnetic, material, such as iron. In the present embodiment, the two magnets 604a1 and 604a3 are radially aligned, and have the same outward magnetization direction. The pair of magnets (604a1, 604a3) have a portion of ferromagnetic material between them and function as magnet 204a1 of FIG. 2, albeit with increased radial thickness. The U-shaped magnetic circuits may be enlarged to receive a bigger coil. Similarly, the magnets 604a2 and 604a4 are radially aligned and have the same inward magnetization direction. Magnets 604a1, and 604a2 are glued on the outer circumference of the cylinder 601, magnets 604a3, and 604a4 are glued on the inner circumference of the cylinder 601. Each pair of magnets 604a1, 604a3 etc. induce magnetic flux in the enclosing U-shaped magnetic circuits in a similar way to magnets 204a1 of FIG. 2. The magnetizable material of the cylinder 601 provides a low reluctance path for the magnetic flux.

Using the design of FIG. 6, coils with larger numbers of turns may be designed, and the thickness of the magnets may be optimized independently of the coil size. Overall, a higher torque density may be achieved.

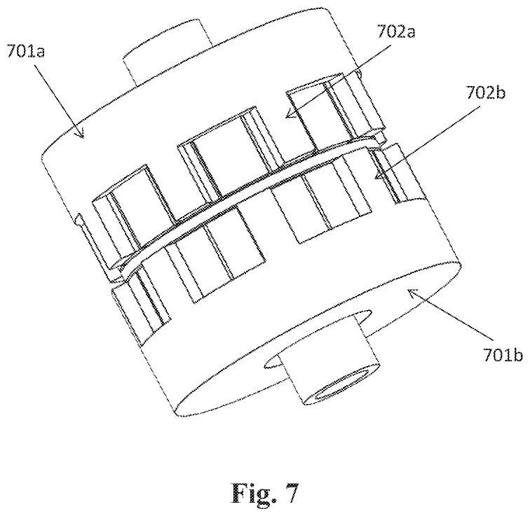

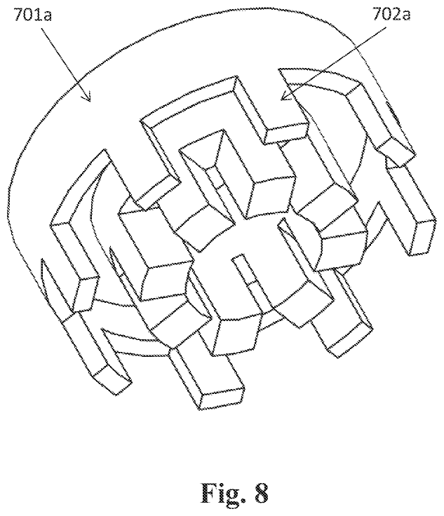

Reference is now made to FIGS. 7 and 8, which show an embodiment in which ferromagnetic material is added between the magnetic circuits. In the embodiment of FIG. 2, there is a number of U-shaped magnetic circuits or magnetic circuit elements (202a, 202b), of which each one is magnetically isolated. Whenever a high current runs in the coil, the magnetic field in the magnetic circuit elements reaches saturation level, thus limiting the maximum output torque of the motor. In order to decrease the magnetic field in the ferromagnetic material, it is possible to increase the volume of each magnetic circuit. This is done by adding ferromagnetic material on each side of the U-shaped magnetic circuit, as shown in FIG. 7.

FIG. 7 shows an embodiment wherein space between magnetic circuits is filled with ferromagnetic material. The bodies 701a and 701b completely fill the spaces between the magnetic circuit, spaces such as 702a and 702b. The two parts 701a and 702a then constitute one volume of ferromagnetic material with teeth. The body itself is shown in FIG. 8. The use of a single volume in this way may reduce the reluctance of the magnetic circuits, increasing the possible current that can be run in coils without saturation and thereby increasing the maximum torque output. The filling material of 701a and 701b may not extend over the magnet ring, to avoid short circuiting of the magnetic field.

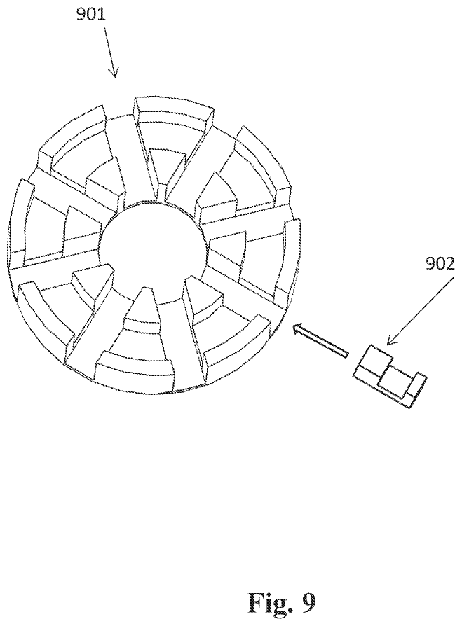

Reference is now made to FIG. 9 which illustrates a practical implementation of part 701a shown in FIG. 8. It is possible to make the same shape, without the teeth, using bulk ferromagnetic material, and with carved cavities, 901, to receive the U-shaped magnetic circuits 902. U-shaped magnetic circuits 902 may be made of laminated material to avoid eddy current losses.

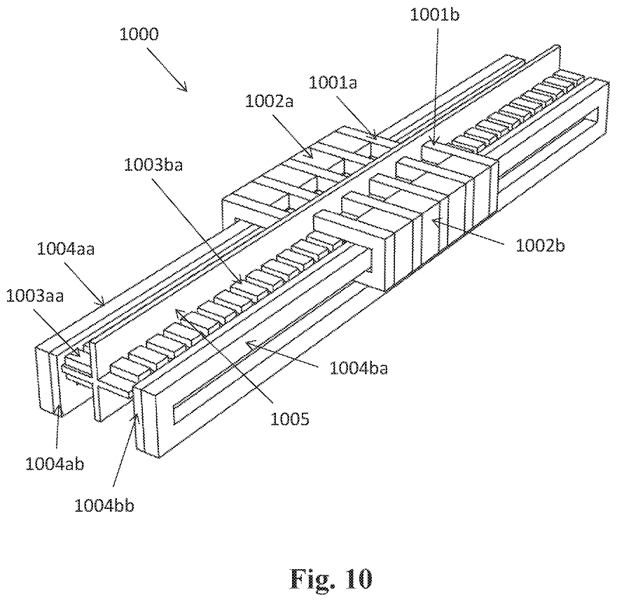

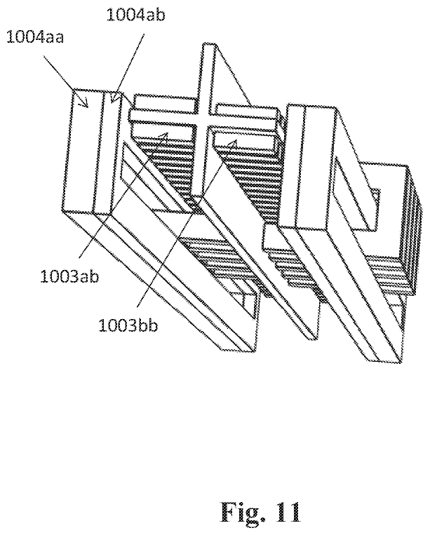

The principles above are also applicable for linear motors, and such an embodiment is now described with reference to FIGS. 10 and 11.

A linear motor (1000) includes a stator and a moving part (mover). The stator includes two sets of two coils (1004aa, 1004ab) and (1004ba, 1004bb). The stator also includes two double rows of magnets (FIG. 10, 1003aa, FIG. 11, 1003ab) and (FIG. 10 1003ba, FIG. 11 1003bb), glued on a structural linear part 1005.

A mover includes U shaped magnetic circuits 1001a and 1001b and elements of ferromagnetic material 102a and 102b between the U-shaped magnetic circuits. The U-shaped magnetic circuits may enclose the coils and receive the double magnet rows in their openings. The elements of ferromagnetic material between the U-shaped magnetic circuits (1002a, 1002b) circuits are also U-shaped, but shorter so that magnet rows do not enter their openings.

All U-shaped magnetic circuits 1001a etc. and all ferromagnetic material elements 1002a etc. are stacked and fixed together to the mover.

All U-shaped magnetic circuits 1001b etc and all ferromagnetic material elements 1002b etc are stacked and fixed together to the mover.

The coils (1004aa, 1004ab) and (1004ba, 1004bb) have long linear sections, so that the mover can slide along these coils, for example by means of linear bearing (not shown).

By the same principle shown above for the rotary motor, a thrust force is obtained when current is run into the coils to move the mover along the coils.

A linear motor of this embodiment has the advantage that coils are static and no electrical wire is needed on the mover.

By the same principle, different configurations of a linear motor may be apparent to the skilled person, for example the following:
a) coils and U-shaped magnetic circuits are on the mover, coils are made shorter to tightly enclose the U-shaped magnetic circuits. In that configuration, moving electrical wires are connected to the coils on the mover.
b) Coils and U-shaped magnetic circuits are on the static part. U-shaped magnetic circuits are distributed on all the linear path.

The mover includes two short double rows of magnets and can slide between the U-shaped magnetic circuits for example by means of linear bearings.

In such a configuration a low inertia mover is obtained, and may allow high acceleration.

In the embodiment of FIGS. 10 and 11, one long section of each coil is not surrounded by magnetic material. It may be desirable to “collect” the magnetic flux around these long sections.

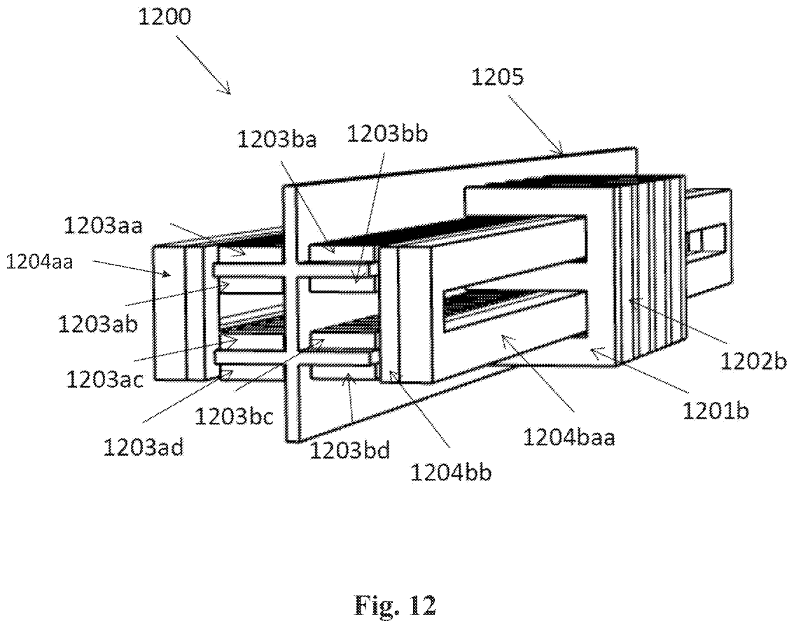

Reference is now made to FIG. 12, which is a simplified schematic diagram showing an embodiment in which both long sections of each coil are surrounded by magnetic circuits.

The linear motor 1200 of FIG. 12 vertically juxtaposes two linear motors 1000 in a single motor structure.

On a stator, four double rows of magnets, 1203aa,1203ab, 1203ba, 1203bb, 1203ac, 1203ad, 1203bc, 1203bd are glued on a common constructive part 1205. Also, on the stator, two long coil sets 1204aa, 120ab and 1204ba, 1204bb are disposed parallel to the rows of magnets. In comparison with the embodiment of FIG. 10, magnet rows are duplicated, but the coils are not duplicated.

On the mover, the magnetic circuits 1201b, 1202b have a double U shape, in order to surround both linear sections of the coils.

The embodiment of FIG. 12 may provide an improved force density by comparison with the embodiment of FIG. 10 since it can produce a double force with the same coils.

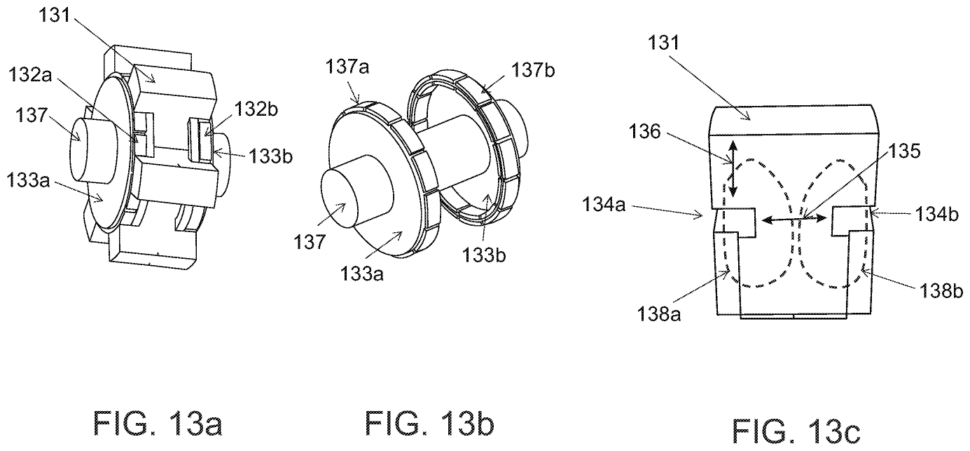

FIGS. 13a, 13b and 13c are three views of an implementation of a rotary motor wherein the two series of magnetic circuits have their openings on opposite sides.

Referring to FIG. 13a, an implementation is shown wherein the two series of U-shaped magnetic circuits have their openings facing opposite directions, and are joined at their far side, forming one series of packs of ferromagnetic material 131. Each pack 131 has two openings 134a and 134b as shown in FIG. 13c. In this implementation, the rotor, shown in FIG. 13b includes two double rings of magnets 137a and 137b, which are spaced apart from each other and fixed to the shaft 137 by means of a support part 133a, 133b.

In FIG. 13c, is shown one pack of ferromagnetic material 131, forming two U shaped magnetic circuits 138a and 138b. An advantage of the implementation of FIGS. 13a-c is that the two magnetic circuits 138a and 138b use the same path 135 between the openings 134a and 134b. In magnetic circuits 138a and 138b the flux of the two motor phases runs. These fluxes have a 90 deg phase difference, so that their respective maximum amplitudes are reached at different times. Hence the total flux maximum amplitude in the path 135 does not exceed the maximum flux amplitude of a single phase. The width of the path 135 may be the same as the width of the path of a single magnetic circuit 403 as shown in FIG. 4 hereinabove. In total, the sharing of flux paths results in a smaller size of the electrical motor.

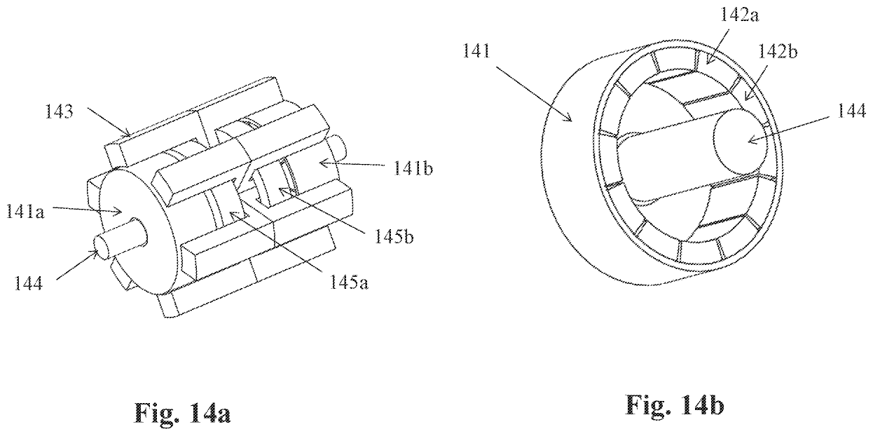

FIGS. 14a and 14b are simplified schematic views showing an implementation of an electric motor according to embodiments of the present invention wherein a single row of magnets is used for each phase.

In FIGS. 14a and 14b is shown an implementation suitable for small diameter motors. In such small motors, there is no room for two magnets in a radial direction. A configuration similar to that shown in FIG. 13 is shown, however only one ring of magnets, 142a, 142b . . . , is mounted inside a cup-shaped part 141 incorporating parts 141a, 141b, for each phase. The outside wall of cup 141 is made of ferromagnetic material and is made thin to allow the running of the magnetic flux.

FIG. 14b shows the rotor of FIG. 14a mounted on shaft 144. Two rotors sit in the U-spaces of oppositely facing magnetic circuits 143. Thus the magnets are located in rings on the insides of two rotors which rotate within oppositely facing U-spaces of a magnetic circuit.

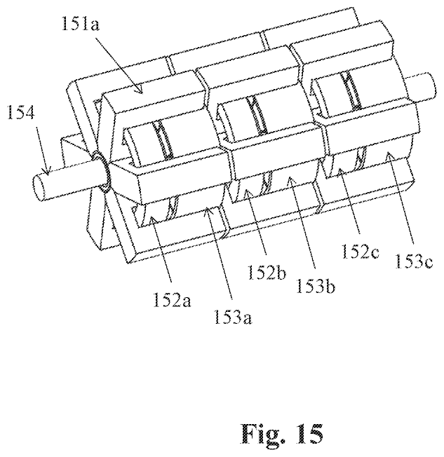

Reference is now made to FIG. 15, which is a simplified schematic diagram showing a three-phase implementation of the motor of FIGS. 14a and 14b, wherein three series of magnets, rings and magnetic circuits are used, one set for each phase according to embodiments of the present invention. More particularly, three sets of cup-shaped supports 153a-c, similar to cup 141 shown in FIG. 14b, are mounted on a common shaft 154 and form the rotor. Inside the cup-shaped supports 153a, three series of U-shaped magnetic circuits 151a-c and circular coils 152a-c form a stator. The three magnet rings are positioned with a 120 degree angular phase difference, i.e. with offsets equal to one third of the angular distance between two magnets of the same polarity.

The three coils 153a-153c are identical and include a single winding.

A motor of the type shown in FIG. 15 can be run using a conventional three-phase drive.

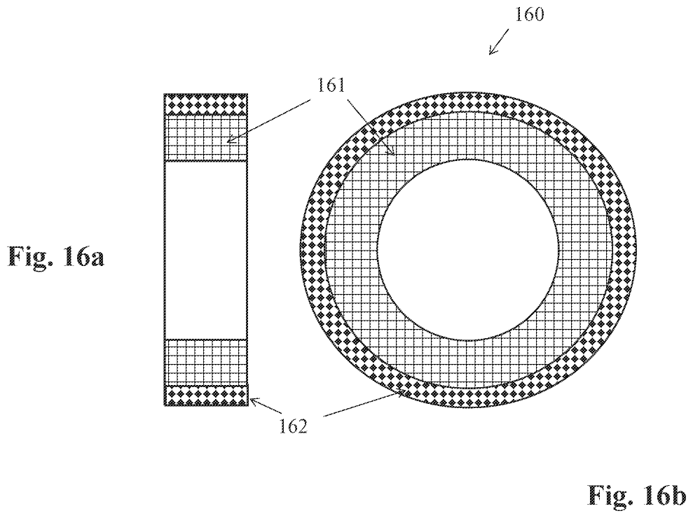

Reference is now made to FIGS. 16a and 16b, which are two cross-sectional views showing a coil arrangement for use in two phase motors run by a three phase drive. In FIGS. 16a and 16b, a coil for a two-phase motor according to the present embodiments includes two circular windings 161 and 162. The number of turns, as described above, has a ratio β=(\sqrt{3}−1)/2, so that if coil 161 has a number of turn N1, then coil 162 has the number of turns N2=N1·(\sqrt{3}−1)/2, or the closest integer number.

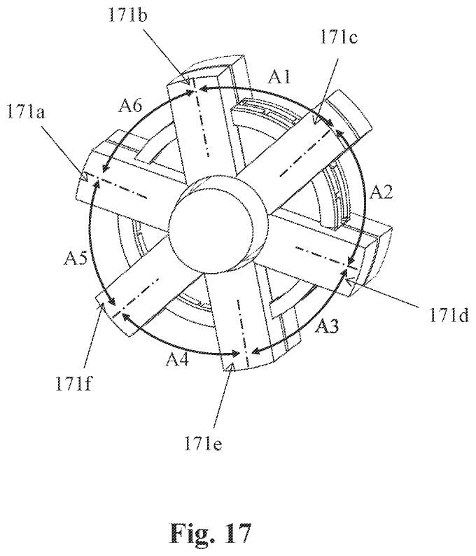

FIG. 17 is a simplified schematic diagram showing a motor according to the present embodiments, wherein the angular distances between the U-shaped magnetic circuit elements are slightly varied to reduce or cancel torque fluctuations resulting from non-harmonic waveform of each phase torque. As shown in FIG. 17, the angular distance between magnetic circuit elements 171a-f are indicated A1-A6. Ideally, the U-shaped magnetic circuit element is equally angularly distributed and the torque of each phase is then a harmonic function of the rotation angle with an amplitude proportional to the current in the correspondent coil. Also, in an ideal case, attraction force between magnets and legs of the U-shaped magnetic circuits of both phases exactly cancel each other out. However, non-harmonic shapes of these torques create torque fluctuations corresponding to the harmonic distortion of the torques, in an effect commonly known as cogging or torque ripple.

In order reduce or even eliminate these torque fluctuations, the relative angular position of each magnetic circuit is made to deviate slightly from the equidistant position. Referring to FIG. 17, a motor is shown having 6 U-shaped magnetic circuits 171a-f for each phase. The angular distances between U-shaped magnetic circuits A1-A6 are given different values such as: An=A0+En, where A0=360deg/(number of U-shaped magnetic circuit)=60deg.

The deviations En are calculated, dependent on the number of U-shaped magnetic circuits, so as to cancel out the greatest number of harmonics of the torque. Thus, the second harmonic is compensated for by the quadrature phase difference between the two phases. The next 2n harmonics may be compensated for by offsetting the angular positions alternatively by +A0/4n and −A0/4n radian. For example, the 4^{th} harmonic is compensated for by offsetting half of the U-shaped magnetic circuits by A0/16 and the second half by −A0/16. Whenever it is desired to compensate for several harmonics { . . . Ni . . . }, linear combinations of the offsets A0/(4.Ni) may be used.

The present design may allow compensation and reduction of the torque fluctuation, at the cost of a slight decrease in the available working torque.

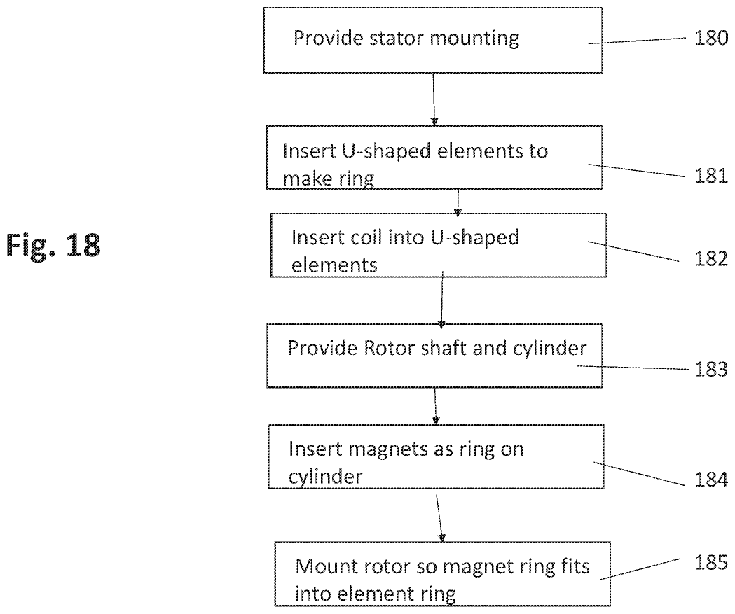

Reference is now made to FIG. 18, which is a simplified diagram illustrating a flow chart for manufacturing a rotating electrical motor according to the present embodiments.

A mounting such as that shown in FIG. 9 forms the basis of the stator and is provided as indicated by box 180. U-shaped elements are fitted into the mounting, again as exemplified in FIG. 9, so as to form a ring of elements—box 181. The U-shaped elements are placed on the mounting so that the open side is oriented to face outwardly from the plate. The mounting may be a plate or a cylinder or the like and is typically made of ferromagnetic material.

A ring-shaped wound coil is then placed into the ring of U-shaped elements—box 182.

A rotor shaft is provided with a cylinder mounted thereon—box 183. Magnets are mounted on or inserted in or fixed on the underside of the cylinder—box 184, again so as to form a ring.

The shaft and cylinder are then placed so as to be rotatable while the magnet ring on the cylinder fits in the element ring alongside coil.

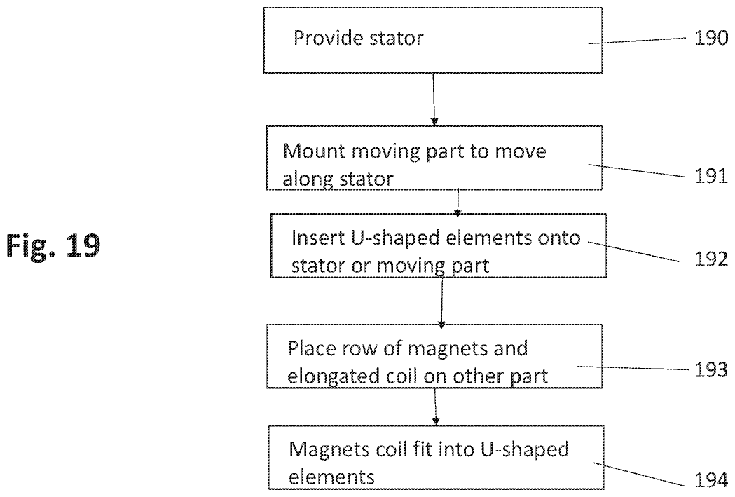

Reference is now made to FIG. 19 which illustrates a method for manufacturing a linear transverse flux motor. In box 190 a static part is provided, and in box 191 a moving part is movably mounted on the static part. Generally, the static part is a rail-like element and the moving part slides along the rail in one of two directions of travel along a travel axis of the motor. That is to say the moving part can go backwards and forwards along the rail in either direction of the travel axis.

The U-shaped elements are inserted—box 192—into either the stator or the moving part and form an element row with the open sides of all elements in the same row being aligned.

The wound coil and a row of magnets are mounted on whichever of the stator and moving part were not used for the U-shaped elements—box 193. The wound coil is elongated and an upper elongated side of the coil is placed alongside the row of magnets. The row of magnets and the upper elongated side of the coil are fitted into the U-shaped elements to be enclosed in the internal space of the U-shaped elements but due to the open side the moving part is still free to move.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A transverse flux rotating electrical motor comprising:
a stator;
a rotor;
the rotor comprising at least one ring of magnets around a shaft, the shaft having an axial direction;
the stator comprising a plurality of U-shaped elements, the U-shaped elements comprising an open first end, a closed second end, and upper and lower legs, said upper and lower legs having respective extents towards said first open end, respective U-shaped elements having a length from said first end to said second end, the u-shaped elements being oriented on said stator such that said length is in said axial direction, said plurality of U-shaped elements being located ringwise around said shaft in at least one ring, wherein said open ends of a respective ring are oriented together in a same direction along said axis;
a plurality of windings, the windings extending ringwise around said shaft and being located within the u-shaped elements.

2. The transverse flux rotating electrical motor of claim 1, wherein said upper and lower legs extend respectively above and below said at least one ring of magnets, thereby to form a magnetic circuit linking said plurality of said windings and said ring of magnets.

3. The transverse flux rotating motor of claim 1, wherein the at least one ring of magnets comprises a plurality of magnetic elements, each having a magnetic orientation in a radial orientation relative to said shaft.

4. The transverse flux rotating motor of claim 3, wherein said magnetic elements have respective magnetic orientations which are alternately inward and outward around said ring.

5. The transverse flux rotating motor of claim 1, wherein the at least one ring of magnets comprise a plurality of magnetic elements, each magnetic element having a cross section in a radial orientation relative to said shaft being one member of the group comprising a parallelepiped and a section of a cylinder.

6. The transverse flux rotating motor of claim 3, wherein each magnetic element comprises a cross section in a radial orientation relative to said shaft being one member of the group comprising a parallelepiped and a section of a cylinder.

7. The transverse flux rotating motor of claim 1, wherein said rotor comprises a cylinder for mounting said at least one ring of magnets, said cylinder defining a space around said shaft to fit respective inner legs of said U-shaped elements between said shaft and said cylinder.

8. The transverse flux rotating motor of claim 1, comprising two of said rings of U-shaped elements and two of said rings of magnets.

9. The transverse flux rotating motor of claim 8, wherein legs of a first of said two rings of U-shaped elements are offset with respect to legs of a second of said two rings of U-shaped elements.

10. The transverse flux rotating motor of claim 1, wherein said stator comprises a plate with gaps for fitting said U-shaped elements.

11. The transverse flux rotating motor of claim 1, wherein said at least one ring of magnets is located centrally of two of said rings of U-shaped elements in said shaft axial direction, respective open ends of said U-shaped elements facing centrally towards said magnet rings in said shaft axial direction, and said plurality of windings being located outwardly of said magnet rings in said shaft axial direction.

12. The transverse flux rotating motor of claim 1, wherein at least two rings of said magnets are located outwardly of two rings of said U-shaped elements in said shaft axial direction, said U-shaped elements of respective rings being placed back to back and said open ends of said U-shaped elements facing towards said magnet rings in said shaft axial direction, respective windings of each ring of U-shaped elements being located inwardly of said magnet rings in said shaft axial direction.

13. The transverse flux rotating motor of claim 1, comprising first and second ones of said rings of U-shaped elements, each of said rings of U-shaped elements containing first and second ones of said windings, said windings being connected such that a three phase current comprises:
a first phase current in a first winding of said first ring of U-shaped elements,
a second phase current in said first winding of said second ring of U-shaped elements, and
a third phase current in both:
a) said second winding of said first ring of U-shaped elements, and
b) said second winding of said second ring of U-shaped elements.

14. The transverse flux rotating motor of claim 1, comprising at least three of said rings of magnets, and at least three of said rings of U-shaped elements.

15. The transverse flux rotating motor of claim 1, wherein said at least one ring of U-shaped elements is arranged such that angular distances between respective U-shaped elements are offset from being equidistant.

16. The transverse flux rotating motor of claim 1, wherein said at least one ring of magnets comprises magnets attached on an inner side of a mounting cylinder radially towards said shaft, and/or said at least one ring of magnets comprises magnets attached on an outer side of a mounting cylinder radially away from said shaft, and/or said at least one ring of magnets comprises magnets attached on an inner side and an outer side of a mounting cylinder radially in relation to said shaft.

17. A transverse flux linear electrical motor comprising:
a stationary part having a travel axis;
a moving part configured to move along said travel axis;
a first one of said stationary and moving parts comprising at least one row of magnets extending along said travel axis and at least one coil having an upper length parallel to said row of magnets;
a second one of stationary and said moving parts comprising a plurality of U-shaped elements, the U-shaped elements respectively comprising an open first end, a closed second end, and upper and lower legs, said upper and lower legs having respective extents towards said first open end, said U-shaped elements having an element length from said first end to said second end, the u-shaped elements being oriented such that said element length is perpendicular to said travel axis, said plurality of U-shaped elements being located lengthwise along said travel axis in at least one row, wherein said open ends of a respective row of U-shaped elements are oriented together in a same direction along said travel axis, wherein the upper and lower legs of said respective U-shaped elements enclose magnets of said row of magnets and a cross section of said upper length of said coil.

18. The transverse flux linear electrical motor of claim 17, wherein said row of magnets is located on said stationary part and said row of U-shaped elements is located on said moving part.

19. The transverse flux linear electrical motor of claim 18, wherein the stationary part comprises a second row of magnets and a second coil and said moving part comprises a second row of U-shaped elements.

20. The transverse flux linear electrical motor of claim 17, wherein said row of magnets is located on said moving part and said row of U-shaped elements is located on said stationary part.

21. The transverse flux rotary or linear motor of claim 1, forming at least part of a robot arm.

22. A method for manufacturing a rotary transverse flux motor comprising:
providing a stator mounting;
inserting U-shaped elements into said stator mounting to form an element ring, said U-shaped elements respectively comprising an open side and an internal space, said open side being oriented to face outwardly from said plate;
inserting a ring-shaped wound coil into said ring of U-shaped elements;
providing a shaft with a cylinder mounted thereon;
mounting magnets on said cylinder to form a magnet ring around said shaft; and
fitting said shaft and said cylinder with respect to said stator mounting such that said shaft and cylinder are rotatable and said magnet ring fits in said element ring alongside said ring-shaped wound coil.

23. A method for manufacturing a linear transverse flux motor comprising:
providing a static part;
providing a moving part;
mounting the moving part movably on the static part to move along a travel axis;
inserting U-shaped elements into a first member of the group consisting of said static part and said moving part, to form an element row, said U-shaped elements respectively comprising an open side and an internal space;
mounting at least one wound coil and a row of magnets on a second member of said group, said wound coil being elongated in said travel axis to provide a first elongated length and a second elongated length, said first elongated length being parallel to and level with said row of magnets;
wherein said magnet row and said first elongated length fit into said internal space.

24. An electrical rotary motor comprising:
a stator, the stator comprising a plurality of U shaped magnetic circuit elements having open ends respectively, and an axis of symmetry, and at least two sets of coils, the U shaped magnetic elements placed in a ring, and the coils inserted into said ring;
a rotor including a shaft and magnets, the magnets being arranged in two rings concentric with the shaft and with alternating radial magnetization directions, the rings of magnets being fixed to the shaft, wherein said stator is arranged around said shaft such that said axis of symmetry of said U shape magnetic circuit elements is parallel to said shaft, and said rings of magnets extend within said U shaped magnetic circuit elements at said respective open ends along with rotation of the motor, magnetic flux thereby running along said U shaped magnetic circuit element in planes parallel to the rotation axis.
